(19) United States
(12) Patent Application Publication
(10) Pub. No.: US 2015/0205356 A1
(43) Pub. Date: Jul. 23, 2015

(54) ELECTRONIC APPARATUS, CONTROL METHOD THEREFOR AND PROGRAM

(71) Applicant: CANON KABUSHIKI KAISHA, Tokyo (JP)

(72) Inventor: Kurumi Mori, Kawasaki-shi (JP)

(21) Appl. No.: 14/601,965

(22) Filed: Jan. 21, 2015

(30) Foreign Application Priority Data
Jan. 22, 2014 (JP) 2014-009877

(51) Int. Cl. G06F 3/01; G06F 3/0485; G06F 3/041

(52) U.S. Cl. CPC G06F 3/016; G06F 3/0416; G06F 3/0485

(57) ABSTRACT

In order to give a tactile signal with sufficient time even in a case where the displayed screen changes at a high speed, if a current scrolling speed is equal to or higher than a preset speed in scrolling a screen, a CPU determines whether a search point exists within a range calculated by multiplying the scrolling speed and a coefficient n within a specific distance in proportion to the current scrolling speed S. If a search point exists, a feedback duration count is reset, and a process for executing a tactile feedback is performed. A larger range is set for determining the presence/absence of a bookmark for a higher playback speed than a low speed to execute a tactile feedback as described above.

### BACKGROUND OF THE INVENTION

1. Field of the Invention

The present invention relates to an electronic apparatus, having a display unit, a control method therefor and a program.

2. Description of the Related Art

In recent years, electronic apparatuses have emerged which may include a display unit having a touch panel to allow intuitive operations thereon. In such an electronic apparatus, a button, a folder or the like on a screen may be touched to invoke various functions.

On the other hand, a size of a display unit attached to a main body of an apparatus supposed to be mobile has been reduced to meet demands for down-sizing of main bodies of the apparatuses. In searching desired data by scrolling a large amount of data list items on a screen of such a display unit, a current position and data delimiters, for example, may be displayed small and be changed quickly so that the search may not be performed easily.

For example, Japanese Patent Laid-Open No. 2006-79238 discloses a technology relating to a touch panel, wherein a touch position detecting unit detects a touch position on a surface of the touch panel, and a vibration control unit vibrates a vibrator with a vibration frequency, vibration interval or vibration intensity based on the touch position to vibrate the touch panel.

Such a technology which gives vibrations or other tactile signals to a user in response to a touch to a touch panel is called a tactile feedback. This technology may be used to give a tactile signal to a user in response to a touch to a content displayed at a specific position on a touch panel.

However, while high-speed scrolling is being performed, for example, a tactile feedback time may be an instant because contents pass by quickly on the viewed screen. Therefore, when a tactile feedback is noticed, the desired content may already have passed by inconveniently.

The present invention may give a tactile signal with a sufficient time even in a case where the displayed screen changes at a high speed.

### SUMMARY OF THE INVENTION

An aspect of the present invention is to solve one of all or at least one of those problems.

An electronic apparatus having a display unit according to an aspect of the present invention includes an identifying unit configured to identify a display content for which a tactile signal is generated, a generating unit which generates a tactile signal if a distance between the display content identified by the identifying unit and a specific position on the screen is equal to or shorter than a specific distance while a screen of the display unit is being scrolled, and a control unit configured to set the specific distance larger for a higher scroll speed for the scroll operation than a lower scroll speed.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration example of an electronic apparatus according to an exemplary embodiment.

FIG. 2 illustrates a display screen example of a display device.

FIG. 3 schematically illustrates a state in which a scroll instruction is input to a screen.

FIG. 4 illustrates virtually assumed display order of thumbnails in a scrolling operation performed on a screen.

FIG. 5 is a flowchart illustrating a tactile feedback process in which a tactile feedback is executed while a screen is being scrolled according to an exemplary embodiment of the present disclosure.

FIG. 6 is a flowchart illustrating details of execution of a tactile feedback process according to an exemplary embodiment of the present disclosure.

FIG. 7 illustrates an example of moving image data.

FIG. 8 is a flowchart illustrating a tactile feedback process to be performed when a tactile feedback is executed while a moving image is being played according to an exemplary embodiment of the present disclosure.

### DESCRIPTION OF THE EMBODIMENTS

Various exemplary embodiments, features, and aspects of the invention will be described in detail below with reference to the drawings.

### First Exemplary Embodiment

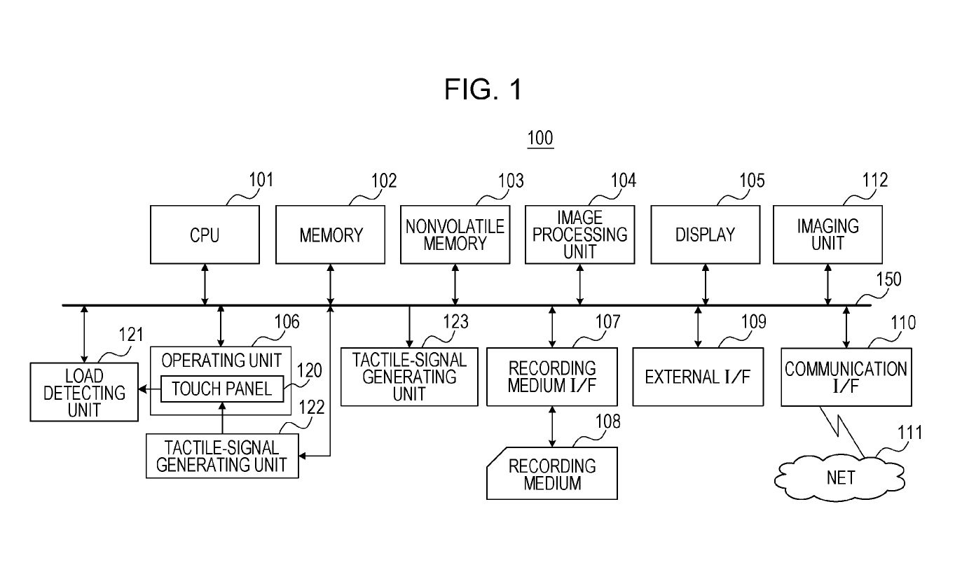

FIG. 1 illustrates a configuration of an electronic apparatus 100 according to a first exemplary embodiment according to the present invention. The electronic apparatus 100 may be configured by a cellular phone, for example. As illustrated in FIG. 1, a CPU 101, a memory 102, a nonvolatile memory 103, an image processing unit 104, a display 105, an operating unit 106, a recording medium I/F 107, an external I/F 109 and a communication I/F 110 are connected to an internal bus 150. Furthermore, an image capturing unit 112, a tactile-signal generating unit 122 and a tactile-signal generating unit 123 are connected to the internal bus 150. These components connected to the internal bus 150 may exchange data with each other via the internal bus 150.

The memory 102 may have a RAM (such as a volatile memory using a semiconductor device), for example. The CPU 101 controls the components of the electronic apparatus 100 by using the memory 102 as a work memory in accordance with a program stored in the nonvolatile memory 103, for example. The nonvolatile memory 103 may store image data, audio data, and other data and a program for operating the CPU 101. The nonvolatile memory 103 may have a hard disk (HD) and a ROM, for example.

The image processing unit 104 performs an image process on image data under control of the CPU 101. Image data on which an image process is to be preformed may be image data stored in the nonvolatile memory 103 or a recording medium 108, a video signal acquired through the external I/F 109, image data acquired through the communication I/F 110, or image data captured by the image capturing unit 112, for example.

Image processes to be performed by the image processing unit 104 may include an A/D conversion process, a D/A conversion process, and an encoding process, a compression process, a decoding process, an enlargement/reduction process (resize), a noise reduction process, color conversion process to be performed on image data, for example. The image processing unit 104 is a dedicated circuit block configured to perform a specific image process, for example. Some types of image process may be executed by the CPU 101 in accordance with a program, instead of the image processing unit 104.

The display 105 displays an image and a GUI screen including a GUI (Graphical User Interface) under control of the CPU 101. The CPU 101 controls the components of the electronic apparatus 100 so as to generate a display control signal in accordance with a program, generate a video signal to be displayed on the display 105, and output them to the display 105. The display 105 displays a video image based on the video signal.

According to an alternative example, the electronic apparatus 100 may not have the display 105 but may have an interface for outputting a video signal to be displayed on the display 105. In this case, the electronic apparatus 100 is assumed to display an image on an external monitor (such as a television).

The operating unit 106 may include a text information input device such as a keyboard, a pointing device such as a mouse, and a touch panel 120, and an input device for receiving a user operation such as a button, a dial, a joy stick, a touch sensor, and a touch pad. The touch panel 120 may be an input device planarly configured over the display 105 to output coordinate information based on a touched position.

The recording medium 108 such as a memory card, a CD, or a DVD may be installed to the storage medium I/F 107. The storage medium I/F 107 may read data from the recording medium 108 to which it is installed or write data to the recording medium 108 to which it is installed under control of the CPU 101.

The external I/F 109 is an interface connected to an external apparatus in a wired or wireless manner for input/output of a video signal and an audio signal. The communication I/F 110 is an interface for performing communication (including telephone communication) with an external apparatus, the Internet 111, or the like to transmit and receive data such as a file and a command.

The image capturing unit 112 is a camera unit which may include an image pickup device such as a CCD sensor or a CMOS sensor, a zoom lens, a focus lens, a shutter, an aperture, a ranging unit, and an A/D convertor. The image capturing unit 112 may capture a still image and a moving image. Image data of an image captured by the image capturing unit 112 may be transmitted to the image processing unit 104. The image processing unit 104 performs a process on the image data, which are then recorded in the recording medium 108 as a still image file or a moving image file.

The CPU 101 receives coordinate information at a touch position output from the touch panel 120 through the internal bus 150. Based on the coordinate information, the CPU 101 detects operations and states including:

an operation for touching the touch panel 120 with a finger or a pen (hereinafter, called a touch-down);

a state in which the touch panel 120 is touched with a finger or a pen (hereinafter, called a touch ON);

an operation for touching the touch panel 120 with a finger or a pen and moving it on the touch panel 120 (hereinafter, called a move);

an operation for removing a finger or a pen touching the touch panel 120 (hereinafter, called a touch-up); and

a state in which nothing is touching the touch panel 120 (hereinafter, called a touch OFF).

If a move is detected, the CPU 101 further determines the moving direction of a finger or a pen based on a change in coordinates of a touch position. More specifically, the CPU 101 determines a vertical component and a horizontal component of the moving direction on the touch panel 120.

The CPU 101 may further detect operations such as a stroke, a flick, and a drag. The CPU 101 detects a stroke when a touch-up is performed from a touch-down through a predetermined move. If a move by a predetermined or longer distance and at a predetermined or higher speed is detected and a touch-up is successively detected, the CPU 101 then detects a flick. If a move by a predetermined or longer distance and at a lower speed than a predetermined speed is detected, the CPU 101 detects a drag.

The “flick” refers to an operation for touching the touch panel 120 with a finger and moving the finger quickly by a distance to certain extent on the touch panel and then removing the finger from the touch panel 120. In other words, the “flick” refers to an operation for quickly tracing on the touch panel 120 with a finger.

The touch panel 120 may have any one of various touch panel systems such as a resistive membrane system, electrostatic capacitance system, a surface acoustic wave system, an infrared system, an electromagnetic induction system, an image recognition system, and an optical sensor system.

A load detecting unit 121 is integrated to the touch panel 120 by adhesion, for example. The load detecting unit 121 may be a distortion gauge sensor configured to use a characteristic that the touch panel 120 bends (distorts) slightly in response to a press of a touch operation to detect a load (press) applied to the touch panel 120. According to an alternative example, the load detecting unit 121 may be integrated to the display 105. In this case, the load detecting unit 121 may detect a load applied to the touch panel 120 through the display 105.

The tactile-signal generating unit 122 generates a tactile signal to be applied to a manipulator such as a finger or a pen which is operating the touch panel 120. The tactile-signal generating unit 122 is integrated to the touch panel 120 by adhesion, for example. The tactile-signal generating unit 122 may be a piezoelectric device, more specifically, a piezoelectric vibrator and vibrates with an arbitrary amplitude and frequency under control of the CPU 101. Thus, the touch panel 120 is curved and vibrated, and the vibrations of the touch panel 120 are transmitted to a manipulator as a tactile signal. In other words, the tactile-signal generating unit 122 vibrates to supply a tactile signal to a manipulator. According to an alternative example, the tactile-signal generating unit 122 may be integrated to the display 105. In this case, the tactile-signal generating unit 122 causes the touch panel 120 to curve and vibrate through the display 105.

The CPU 101 changes the amplitude and frequency settings of the tactile-signal generating unit 122 to vibrate the tactile-signal generating unit 122 in various patterns and thus generate tactile signals having various patterns.

The CPU 101 controls a tactile signal based on a touch position detected on the touch panel 120 and a press detected by the load detecting unit 121. For example, it is assumed that in response to a touch operation performed by a manipulator, the CPU 101 has detected a touch position corresponding to a button icon displayed on the display 105 and that the load detecting unit 121 has detected a press equivalent to a predetermined or higher value. In this case, the CPU 101 generates vibrations for about one period. Thus, a user may perceive a tactile signal such as a sense of click which may occur as if a mechanical button is pushed.

The CPU 101 is assumed to execute a function corresponding to a button icon only in a case where a touch of the position of the button icon is detected and a press corresponding to a predetermined or higher value is detected. In other words, the CPU 101 does not execute a function corresponding to a button icon if a weak press is detected as in a case where the button icon is just touched. Thus, a user may operate in a similar sense as if he or she pushes a mechanical button.

The load detecting unit 121 is not limited to such a distortion gauge sensor. According to an alternative example, the load detecting unit 121 may have a piezoelectric element. In this case, the load detecting unit 121 may detect a load based on a voltage output from the piezoelectric element in response to a press. A pressure element functioning as the load detecting unit 121 in this case may be common to a pressure element functioning as the tactile-signal generating unit 122.

The tactile-signal generating unit 122 is not limited to one which generates vibrations by using a pressure element. According to an alternative example, the tactile-signal generating unit 122 may generate an electrical tactile signal. For example, the tactile-signal generating unit 122 may have a conductive layer panel and an insulator panel. Here, the conductive layer panel and insulator panel may be planarly provided over the display 105, like the touch panel 120. When a user touches the insulator panel, the conductive layer panel is charged with positive electric charges. In other words, the tactile-signal generating unit 122 may generate a tactile signal as an electrical stimulation by charging the conductive layer panel with positive electric charges. The tactile-signal generating unit 122 may further give a user a sense (tactile signal) as if the skin is pulled by a Coulomb force.

According to another example, the tactile-signal generating unit 122 may have a conductive layer panel which allows selection of whether the panel is to be charged with positive electric charges or not in accordance with a position on the panel. The CPU 101 may control a position for charging positive electric charges. Thus, the tactile-signal generating unit 122 may give a user various tactile signals (feel of touch) such as “rugged”, “rough” and “smooth and dry”.

The tactile-signal generating unit 123 may vibrate the entire electronic apparatus 100 to generate a tactile signal. The tactile-signal generating unit 123 may have an eccentric motor, for example, for implementing a publicly known vibration function. Thus, with vibrations generated by the tactile-signal generating unit 123, the electronic apparatus 100 may give a tactile signal to a hand of a user holding the electronic apparatus 100.

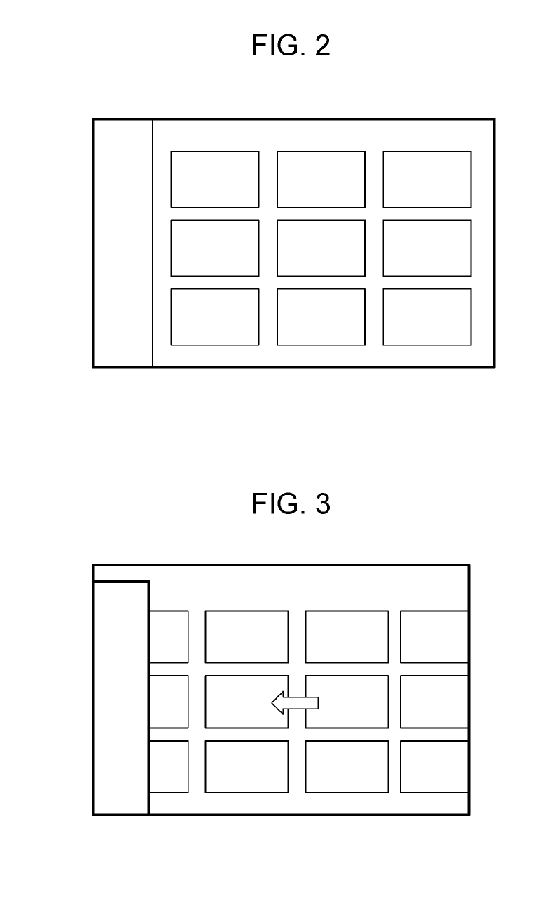

FIG. 2 is a display screen example of the display 105 which is a display unit. On the screen, a plurality of thumbnails generated from image data recorded in a recording medium are index-displayed.

While the screen is still in the state illustrated in FIG. 2, the scrolling of the screen is started as illustrated in FIG. 3 when a scroll instruction for a screen such as a flick is input by a user.

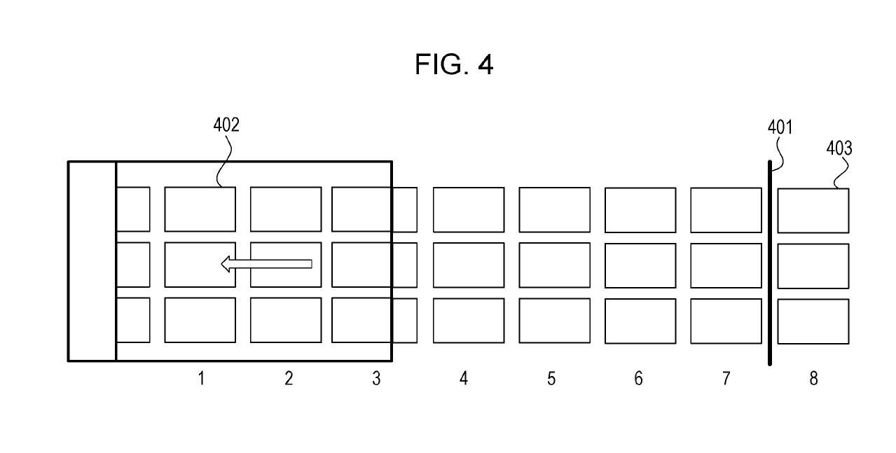

FIG. 4 illustrates display order of thumbnails virtually assumed when a screen is scrolled. A thumbnail group before a thumbnail of the seventh column (upstream in the scroll direction of the screen) counting from the thumbnail at a beginning position of the screen corresponds to data recorded at a different date (see a date delimiter 401).

In order to notify a user of a meaningful data search such as a date delimiter, the electronic apparatus 100 executes a tactile feedback control which uses the tactile-signal generating unit 122 to give a tactile signal.

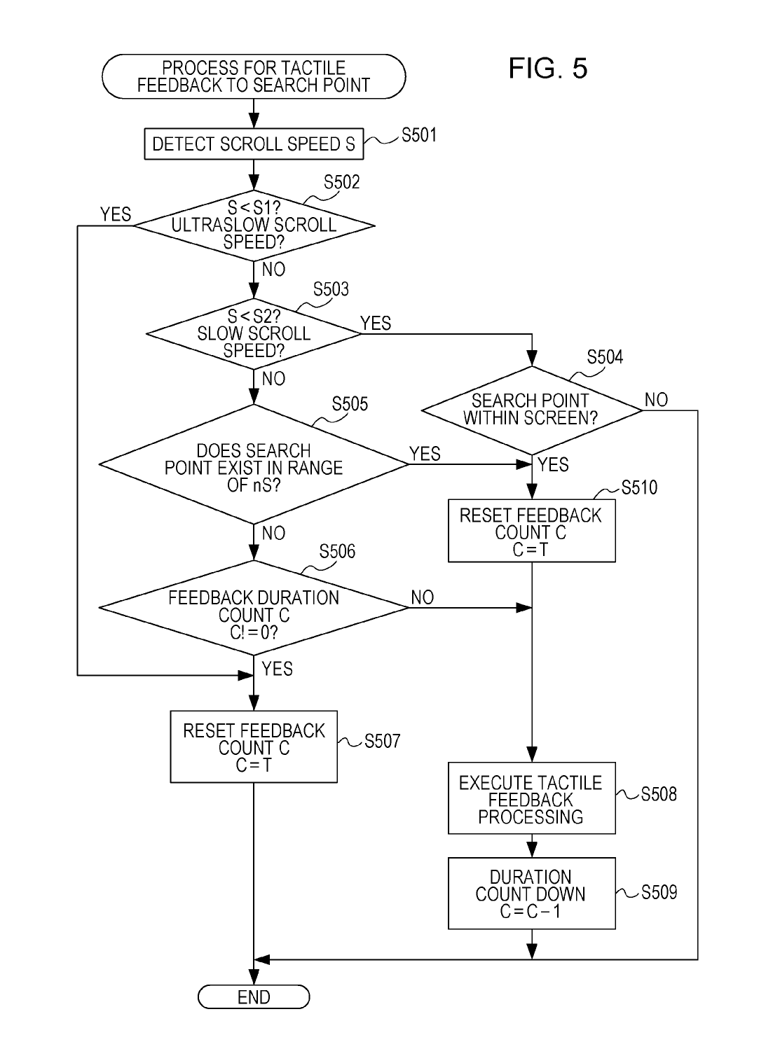

FIG. 5 is a flowchart illustrating a tactile feedback process for executing a tactile feedback with respect to a search point when a screen is scrolled. The process illustrated in FIG. 5 is implemented by the CPU 101 in the electronic apparatus 100 by executing a program.

When a tactile feedback process for the search point is started, the CPU 101 detects a current scrolling speed S of the screen (step S501). Then whether the current scrolling speed S is lower than a preset speed S1 or not is determined (step S502). If it is lower than the speed S1, the process moves to step S507. If it is equal to or higher than the speed S1, the process moves to step S503.

In step S507, the CPU 101 resets a feedback duration count for continuing the tactile feedback and ends the process. The feedback duration count is set in order to continue a tactile feedback even when a target thumbnail passes by due to a scroll speed and to increase a notification time to a user. This may provide a tactile feedback having an aftereffect.

In step S503, the CPU 101 determines whether the current scrolling speed S is lower than a preset speed S2 (>S1) or not. If it is lower than the speed S2, the process moves to step S504. If it is equal to or higher than the speed S2, the process moves to step S505.

In step S504, whether a search point which is a display content for which a tactile signal occurs exists within a screen or not is determined. According to this exemplary embodiment, the term “search point” refers to a first thumbnail within a next thumbnail group divided by the date delimiter 401. In the example in FIG. 4, it corresponds to an eighth thumbnail 403 counting from a thumbnail 402 (or an item displayed on the screen) at an upper left end of the screen. If a search point exists within the screen, the feedback duration count is reset (step S510), and a process for executing a tactile feedback is performed (step S508). The feedback duration count is then decremented (step S509), and the process ends. If no search point exists within the screen, the process ends.

In step S505, the CPU 101 determines whether a search point exists within a range calculated by multiplying the scrolling speed S by a coefficient n within a specific distance in proportion to the current scrolling speed S. If a search point exists, the process moves to step S510. If not, the process moves to step S506.

In step S506, whether the feedback duration count has terminated or not is determined. If the feedback duration count has not terminated, the process moves to step S508 where the execution of the tactile feedback process continues. If it has terminated, the process moves to step S507.

As described above, for a higher scroll speed than a lower scroll speed, the range for determining the presence/absence of a search point is set larger to execute a tactile feedback. Thus, there may be a sufficient time for giving a tactile signal, which improves searchability.

The time for generating a tactile signal is set to a predetermined time period (feedback duration count) irrespective of the range for determining the presence/absence of a search point, which may avoid a tactile signal from being difficult to perceive due to a short presenting time period.

If the scrolling speed S is lower than the preset speed S1, the tactile feedback is inhibited. If the scroll speed allows a user to visually recognize a screen sufficiently, there may be a high possibility for a user to perform an operation excluding searching. Accordingly, higher priority is given to a tactile signal based on other operations than tactile feedbacks based on a positional relationship between a displayed thumbnail and a search point to provide proper feedback details to a user.

### Second Exemplary Embodiment

Next, a second exemplary embodiment will be described. An electronic apparatus 100 according to the second exemplary embodiment may have the same configuration as the one illustrated in FIG. 1, and the description will be omitted.

The display contents on a screen according to the second exemplary embodiment are the same as those of the first exemplary embodiment. The tactile feedback process is performed in accordance with the same flowchart as that of the first exemplary embodiment. The second exemplary embodiment is different from the first exemplary embodiment in details of execution of a feedback process in FIG. 5.

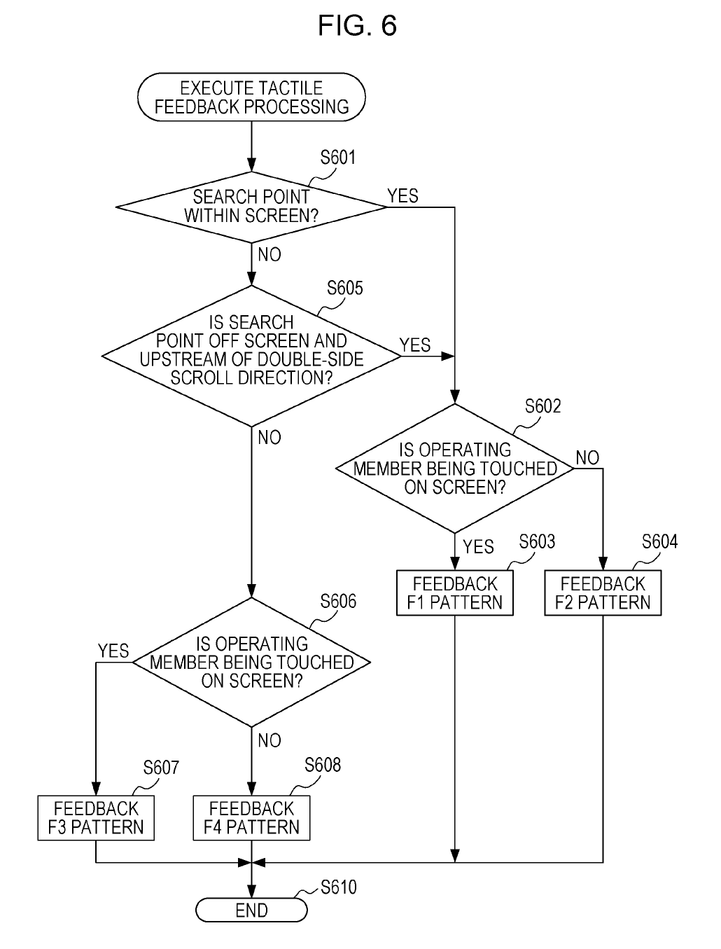

FIG. 6 is a flowchart illustrating details of execution of a tactile feedback process.

The CPU 101 determines whether a search point exists within a screen or not (step S601).

If it is determined in step S601 that a search point exists within the screen, the CPU 101 determines whether a touch of an operating member onto the screen has occurred or not (step S602). If a touch of an operating member has occurred, the process moves to step S603 where a tactile feedback is performed by using an F1 pattern. In this case, the tactile feedback is performed by the tactile-signal generating unit 122, and a tactile signal is directly given to an operating member by a finger, for example, performing a screen touch. On the other hand, if no touch of a touch member has occurred, the process moves to step S604 where a tactile feedback is performed by using an F2 pattern. The tactile feedback in this case is performed by the tactile-signal generating unit 123, and a tactile signal is given to a whole body to allow notification to a user of a state without a screen touch.

If no search point exists within the screen in step S601, whether a search point exists off the screen and in an upstream of the scroll direction or not is determined (step S605). If a search point exists off the screen and in an upstream of the scroll direction (or a search point has not appeared on the screen yet), the process moves to step S602. If a search point exists off the screen but not in an upstream of the scroll direction (or a search point has passed by), the process moves to step S606. In step S606, whether a touch of an operating member onto the screen has occurred or not is determined. If a touch of an operating member has occurred, the process moves to step S607 where a tactile feedback is performed by using an F3 pattern. In this case, the tactile feedback is performed by the tactile-signal generating unit 122, and a tactile signal is directly given to an operating member by a finger, for example, performing a screen touch. However, the F3 pattern is different from the F1 pattern. On the other hand, if no touch of a touch member has occurred, the process moves to step S608 where a tactile feedback is performed by using an F4 pattern. In this case, the tactile feedback is performed by the tactile-signal generating unit 123, and a tactile signal is given to a whole body to allow notification to a user of a state without a screen touch in a different way from the F2 pattern. However, the F4 pattern is different from the F2 pattern.

As described above, the type of tactile signal may be changed such that a user may grasp a positional relationship regarding whether a search point has not appeared or passed by on a screen yet. In this case, the type of tactile signal may be changed in accordance with how the screen is being touched. More specifically, if a screen is being touched, a tactile signal is directly given to an operating member by a finger, for example, performing the screen touch. If the screen is not being touched, a tactile signal is given to a whole body. Thus, a more appropriate tactile feedback may be performed.

It should be noted that details of tactile feedback patterns are not particularly limited. For example, various presenting methods may be available such as changing intensity of a tactile signal, changing a time interval for giving a tactile signal during a period while a touch is being performed, changing a position to give a tactile signal (reducing or increasing, for example, an area for giving a tactile signal about a touch position), and changing the number of times and a period for giving a tactile signal, and patterns may be generated by using different presenting methods.

### Third Exemplary Embodiment

Next, a third exemplary embodiment will be described. An electronic apparatus 100 according to the third exemplary embodiment may have the same configuration as the one illustrated in FIG. 1, and the description will be omitted.

According to the third exemplary embodiment, there will be described a tactile feedback example in accordance with a user operation while a moving image is being played at a variable playback speed.

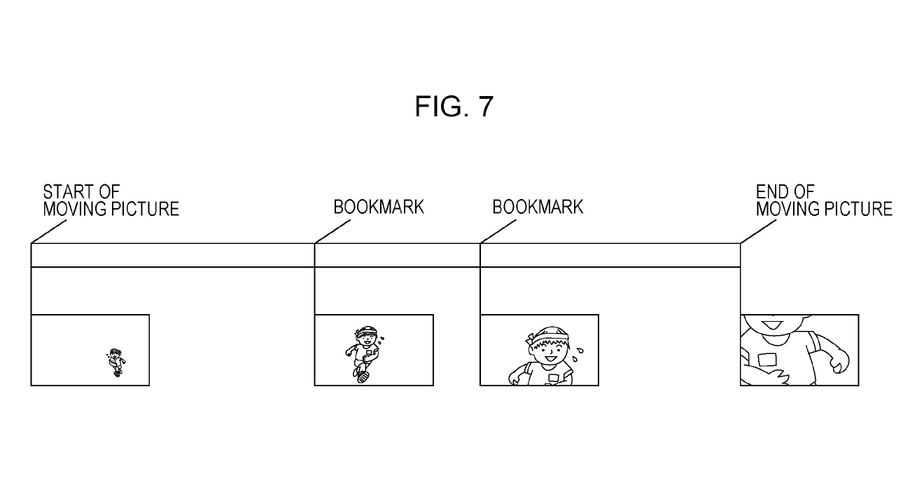

It is assumed here that a bookmark preset in a moving image is searched by adjusting the playback speed of the moving image. Such a bookmark is a sign for quickly finding a desired scene later. By operating a skip button, the playback position may be moved quickly to a scene before or after a position where the bookmark is given. Such a bookmark may sometimes be called a chapter. FIG. 7 illustrates an overview of moving image data. Bookmarks which are display contents at which a tactile signal may occur are set at two points from a starting point of the moving image data. A user is allowed to control the playback speed by operating the operating unit 106 while the moving image is being played. In order to notify a user of that a scene being played and displayed is close to a position of one of the bookmarks, information supply by giving a tactile signal is allowed.

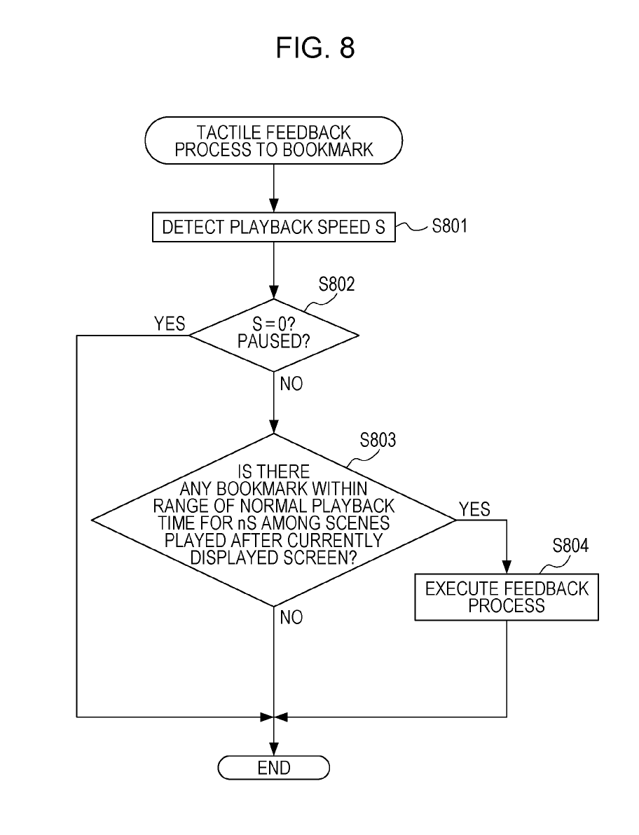

FIG. 8 is a flowchart illustrating a tactile feedback process for executing a tactile feedback to a bookmark while a moving image is being played. The process illustrated in FIG. 8 is implemented by the CPU 101 in the electronic apparatus 100 by executing a program.

When a tactile feedback process to a bookmark starts, the CPU 101 detects a current playback speed S (step S801), and the process moves to step S802. In step S802, whether it is a pause state or not is determined. If it is a pause state, the process ends. If not, the process moves to step S803. While it is a pause state (playback speed S=0) or not is determined here, other speeds may be set as determination criteria.

In step S803, the CPU 101 determines whether a bookmark exists within a specific distance in proportion to a current playback speed S (within a normal playback time for seconds equivalent to a product Sn of a playback speed S and a coefficient n. If a bookmark exists, a process for executing a tactile feedback is performed to previously notify that a scene corresponding to the bookmark is to be played (step S804), and the process ends. If no bookmark exists, the process ends.

As described above, a time interval between a scene being played and a specific scene is set as a specific distance. Instead of such a time interval, a frame number or a scene number may be set as such a specific distance.

A larger range is set for determining the presence/absence of a bookmark for a higher playback speed than a low speed to execute a tactile feedback as described above. Thus, a tactile signal may be given in good timing with a sufficient time, which may improve searchability.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-009877, filed Jan. 22, 2014, which is hereby incorporated by reference herein in its entirety.

What is claimed is:

1. An electronic apparatus having a display unit, the apparatus comprising:
an identifying unit configured to identify a display content for which a tactile signal is generated;
a generating unit which generates a tactile signal if a distance between the display content identified by the identifying unit and a specific position on the screen is equal to or shorter than a specific distance while a screen of the display unit is being scrolled; and
a control unit configured to set the specific distance larger for a higher scroll speed for the scroll operation than a lower scroll speed.

2. The electronic apparatus according to claim 1, wherein the control unit sets a constant period for generating a tactile signal irrespective of the specific distance.

3. The electronic apparatus according to claim 1, wherein the control unit changes a type of tactile signal to be generated in accordance with a positional relationship between the display content identified by the identifying unit and the specific position on the screen.

4. The electronic apparatus according to claim 1, wherein the control unit does not generate a tactile signal if the scroll speed is lower than a preset speed.

5. The electronic apparatus according to claim 1, wherein the control unit changes a type of tactile signal to be generated in accordance with whether a touch of an operating member onto a screen has occurred or not.

6. An electronic apparatus which plays a moving image at a variable playback speed and displays it on a display unit, the apparatus comprising:
an identifying unit configured to identify a scene in a moving image for which a tactile signal is generated;
a generating unit configured to generate a tactile signal if a distance in display order between the scene of the moving image displayed on a screen of the display unit and a scene identified by the identifying unit is equal to or shorter than a specific distance while the moving image is being played; and
a control unit configured to set the specific distance larger for a higher playback speed than a lower playback speed.

7. A control method for an electronic apparatus having a display unit, the method comprising:
identifying a display content for which a tactile signal is generated; and
generating a tactile signal if a distance between the display content identified by the identifying unit and a specific position on the screen is equal to or shorter than a specific distance while a screen of the display unit is being scrolled,
wherein the generating includes setting the specific distance larger for a higher scroll speed for the scroll operation than a lower scroll speed.

8. A control method for an electronic apparatus which plays a moving image at a variable playback speed and displays it on a display unit, the method comprising:
identifying a scene in a moving image for which a tactile signal is generated; and
generating a tactile signal if a distance in display order between the scene of the moving image displayed on a screen of the display unit and a scene identified by the identifying unit is equal to or shorter than a specific distance while the moving image is being played,
wherein the generating includes setting the specific distance larger for a higher playback speed than a lower playback speed.

9. A program for controlling an electronic apparatus having a display unit, the program causing a computer to execute:
identifying a display content for which a tactile signal is generated; and
generating a tactile signal if a distance between the display content identified by the identifying unit and a specific position on the screen is equal to or shorter than a specific distance while a screen of the display unit is being scrolled; and
setting the specific distance larger for a higher scroll speed for the scroll operation than a lower scroll speed.

10. A program for controlling an electronic apparatus which plays a moving image at a variable playback speed and displays it on a display unit, the program causing a computer to:
identifying a scene in a moving image for which a tactile signal is generated;
generating a tactile signal if a distance in display order between the scene of the moving image displayed on a screen of the display unit and a scene identified by the identifying unit is equal to or shorter than a specific distance while the moving image is being played; and
setting the specific distance larger for a higher playback speed than a lower playback speed.
